(19) United States
(12) Patent Application Publication
(10) Pub. No.: US 2009/0212920 A1
(43) Pub. Date: Aug. 27, 2009

(54) INTELLIGENT ASSET PROTECTION SYSTEM

(76) Inventor: Xiao Hui Yang, Los Altos, CA (US)

Correspondence Address: WATERS LAW GROUP PLLC, 714 Lyndon Lane, Suite 6, Louisville, KY, 40222, US

(21) Appl. No.: 12/391,252

(22) Filed: Feb. 23, 2009

Related U.S. Application Data
(60) Provisional application No. 61/030,929, filed on Feb. 22, 2008.
(60) Provisional application No. 61/030,932, filed on Feb. 22, 2008.

(51) Int. Cl. H04Q 5/22

(52) U.S. Cl. 340/10.3

(57) ABSTRACT

An intelligent asset protection system is claimed and disclosed which features a plurality of devices are used to protect a retail establishment by radiating and detecting into a protection zone to identify transponders within a given area. These devices that radiate and detect are typically located in the ceiling or above the area that is desired to be monitored and create a cone shaped interrogation field which expands as it is broadcast downward into the monitored area. In communication with the RAD units, the system uses transponders capable of storing information which includes passwords and unique identifiers as well as information about the object to which the transponder is attached. The transponder is capable of responding to a RAD unit and broadcasting information to it which may include the information stored on the transponder. The transponder in some embodiments will have a battery located on board, but the transponder will remain in an inactive sleep mode until a RAD unit contacts it with a radiated

### RELATED U.S. APPLICATION DATA

This application claims priority from U.S. provisional application No. 61/030,929, filed on Feb. 22, 2008, and U.S. provisional application No. 61/030,932 filed on Feb. 22, 2008. The entire disclosure contained in U.S. provisional application 61/030,929 and U.S. provisional application No. 61/030,932, including the attachments thereto are incorporated herein by reference.

### BACKGROUND OF THE INVENTION

A common logistical concern in businesses is the tracking of assets or persons. In retail, one example of this logistical tracking concern is shoplifting. Many retail establishments employ electronic tags attached to goods that can be detected by systems installed for that purpose. A common term for these systems, tags, etc. is electronic article surveillance, or EAS.

Many of these tags and systems are only capable of registering the presence of the tag. Transmitters and receivers are located at exit points within a retail environment and the transmitter creates an interrogation zone at the exits while the receivers scan for responses from tags passing through the interrogation zone. There are several types of tags for these systems, one of which is a harmonic tag and another of which is a resonance tag. With the harmonic tag the electromagnetic interrogation field charges the circuitry of the harmonic tag, and when the interrogation field is turned off this energy dissipates from the tag and produces a signal which is a harmonic of the interrogation field. With the resonant tags, the resonant tags vibrate with the interrogation field and produce a signal from this harmonic resonant. The system is tuned to the expected frequencies whether they are harmonic tags or resonant tags, and the receiver antennas of the system detect these signals. When a signal is detected by an interrogation field, it is assumed that a tag is present and that it is improperly being removed from the retail facility. Similar systems may also be used to identify authorized personnel. In these cases, the tags might be identification badges, and the badges are only capable of indicating that an authorized person is present, for example, at an access door.

With the improvement of electronic circuitry and miniaturization, tags capable of doing more than just announce their presence are being developed. Theses tags may have onboard power supplies to allow them to power programmable circuits that transmit information in digital form. This information may be as simple as a unique identifier of the tag, or the transmission from the tag might include information about the object to which the tag is attached. This information is programmed into a tag at the time the tag is attached to an object. Many of these systems also use a transmitting antenna to prod the tags into responding. Various schemes are used to prevent more than one tag from responding at the same time. This prevents the tags from interfering with each other's signals. Other systems employ a scheme where tags pseudo randomly chirp out their identifier, so that the receiver of a system may note their presence and in many cases calculate their physical location by the signal.

Similar to the tag system above, personnel monitoring systems utilize identification tags which respond when queried. Again, these tags would most typically only broadcast when prodded by a system signal. This allows the batter on such a tag to last longer and prevents interference from random signals from multiple tags.

### RELEVANT ART

U.S. Pat. No. 6,483,427 by Werb discloses an article tracking system. The article tracking system uses cell controllers with multiple antenna modules to monitor the desired space. Each cell controller alternately operates various multiple antennas to create interrogation zones by each antenna. The antennas can prompt transponders within their areas to respond with the signal and receive information from the transponders. This information is processed by the cell controllers and transmitted back to a central computer. The cell controllers can be powered by typical wall outlets. The use of multiple antennas allows a transponder to be in constant range of the system and the system can also track the movement or relocation of a transponder as different antennas detect and transmit the information back through the cell controllers to a central computer. The information function of the system and its power requirements are provided separately.

U.S. Pat. No. 6,570,487 by Steeves discloses and claims a distributed tag reader system and method. Steeves employs independent tag readers and door controls at entries and exits to controlled areas. Each tag detector and door control is able to operate independently and when a tag is detected, it to evaluate whether the bearer of that tag is entitled to entry. A central application program interface provides for programming and database access to set appropriate access levels for given tags. The independent detection and control devices are networked together to the central application programming interface. The networked access modules are capable of receiving information from other modules and transmitting those through the network to the central computer.

U.S. Pat. No. 7,176,797, by Zai, et al. discloses an electronic article surveillance (EAS) system that uses a large zone electronic article detector with several smaller zone electronic article detectors operating within the larger zone. Each of the smaller zone detectors does not overlap with any of the other smaller zone detectors, and each of the smaller zone detectors operates on a different frequency from neighboring small zone detectors. If an EAS tag or transponder is not detectable by a smaller zone detector, it is detected by the larger zone detector. The system associates the tag with the detector that has located the tag or transponder. The tags themselves can operate at the different frequencies in which the several electronic article detectors operate. The electronic article detectors can operate at several different frequencies, but they are arranged and programmed so that their frequencies are different from immediate neighbors.

### SUMMARY OF THE INVENTION

A plurality of devices are used to radiate and detect transponders within a given area. These devices that radiate and detect are referred to as radiation and detection units or RADs or RAD units. The RAD units are typically located in the ceiling or above the area that is desired to be monitored. They create a cone shaped interrogation field which expands as it is broadcast downward into the monitored area. The RAD units can be located densely enough to thoroughly cover the floor level area being monitored.

In conjunction with the RAD units, the system uses transponders which are attached to the objects being monitored. The transponders are capable of storing information which includes passwords and unique identifiers for each transponder, as well as information about the object to which the transponder is attached. The transponder is capable of responding to a RAD unit and broadcasting information to it which may include the information stored on the transponder. The transponder in some embodiments will have a battery located on board, but the transponder will remain in an inactive sleep mode until a RAD unit contacts it with a radiated signal. At that time, the transponder awakens, recognizes the RAD unit, and transmits information as requested by the RAD unit, and the RAD unit detects the signal from the transponder. If the transponder has been associated within the system with an article, this unique transponder identifier will serve to identify that article.

In addition to surveying the quantity of transponders present in its area and determining which transponders are there, one embodiment of the system can determine the physical location of a transponder. There are several algorithms which may be used to accomplish this by using the time it takes the transponder to respond to the RAD unit. Some algorithms can utilize the interaction of a given transponder with more than one RAD unit to more accurately determine the location of the transponder.

In addition to storing and communicating information, the transponder can provide a security function, RAD units positioned near security exits, such as store exits in retail situations, can instruct the transponder to emit an alarm signal. This alarm signal can be instructed to continue until instructed otherwise or until the battery is discharged. The transponder alarm signal can also be triggered by an unauthorized attempt to forcibly remove the transponder from an object. Again, in the case where a transponder is alarming, because an attempt has been made to forcibly remove it, the transponder can alarm until the battery is discharged or until a RAD unit instructs it to cease alarming. In one embodiment, the transponder will require confirmation of its password before executing certain instructions from a RAD; instructions such as to cease self alarm, etc.

Each RAD unit is connected to a server via cables and a switch. The cables, or wires, connecting each RAD unit to the switch are capable of both transmitting data and conducting power for the RAD unit. Data transmission via the cables is bidirectional and the information transmitted can be instructions and programming traveling from the server to individual RADs and transponders as well as information traveling from transponders and RADs to the server. The switch supplies power to the cables for the RAD units. From the switch, information is conducted to the server, and the switch can also perform data traffic control in some embodiments. A common type of switch used for this purpose is a Power over Ethernet (PoE) switch.

The server performs both database and control functions. Software on the server allows a user to set instructions for each individual RAD unit and how that RAD unit communicates with the transponders. It is also possible to reprogram information on transponders via the RAD unit that is closest to the transponder. The server software allows RAD units located near entries and exits to operate differently from RAD units out in an area of general inventory. The server database may track the location of the inventory and changes in that inventory. Along with transponders placed in inventory, the server and RAD units may interact with personnel ID badges to monitor personnel activity, in particular, with regard to high value inventory, or in other applications to provide access control.

Transponders may come in a large variety of embodiments. This large variety results from several factors including whether the transponders will be interacting with multiple systems, the types of system, and the level of functionality desired by a user of the systems and transponders. For example if transponders will be operating in an environment where an EAS system is deployed for detecting passive tags, the transponders may have EAS sensors such as EAS ferrites or EAS resonators. Various embodiments of the transponder may have a microprocessor, digital controllers, memory, internal antennas, an audible alarm generator, attachment mechanisms, tamper detection means, light emitting diodes for visible alarms, clock, supplemental communication means such as infrared capabilities, batteries, etc.

### BRIEF DESCRIPTION OF THE DRAWINGS

Additional utility and features of the invention will become more fully apparent to those skilled in the art by reference to the following drawings, which illustrate the primary features of the preferred embodiment.

FIG. 1 is a perspective view of an asset protection system according to one embodiment of the invention.

FIG. 2 provides a closer view of some of the elements of the system in the embodiment shown in FIG. 1.

FIG. 3 shows a view of an embodiment of a RAD unit.

FIG. 4 shows several embodiments of transponders 30.

FIG. 5 is a top perspective view of tack attached tag compatible with the intelligent asset protection system of one embodiment.

FIG. 6 is a bottom perspective view of the tack attached tag of FIG. 5.

FIG. 7 is an exploded perspective view of the tack attached tag of FIGS. 5 and 6.

FIG. 8 is a perspective view of a lanyard tag compatible with the intelligent asset protection system of one embodiment.

FIG. 9 is a top view of the lanyard tag of FIG. 7.

FIG. 10 is a bottom view of the lanyard tag of FIG. 7.

FIG. 11 is a perspective view of the lanyard tag of FIG. 8 with the outer shell made transparent.

### DETAILED DESCRIPTION OF EMBODIMENTS

The detailed description below is for embodiments intended to illustrate and explain the current invention. It is to be understood that a variety of other arrangements are also possible without departing from the spirit and scope of the invention. Where appropriate, the same numbering will be used when discussing different embodiments.

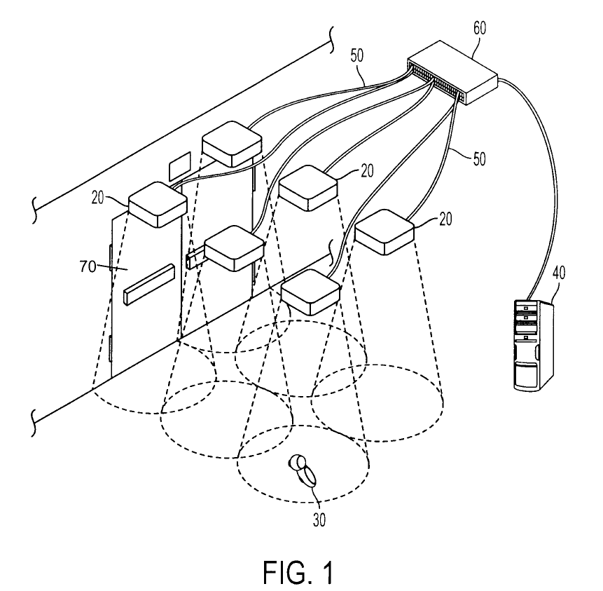

FIG. 1 is a schematic view of the asset protection system 10. A plurality of radiation and detection units (RAD units) 20 are used by the asset protection system 10 to monitor an area. In one embodiment, each RAD 20 has at least a programmable controller, memory, signal transmitting and receiving means, and a cable receptacle for receiving a cable for transmitting power and data. Each RAD unit 20 is independently capable of radiating an area and also scanning for reply signals. In one embodiment the RAD units 20 are mounted overhead. This allows the entire target area to be monitored without intrusive installations at the level where persons and objects will be located. RAD units 20 operate to detect transponders 30 as shown in FIG. 1.

Transponders 30 are capable of detecting a signal from RAD units 20 and responding. IN at least one embodiment, communications between RAD units 20 and transponders 30 is in the radio frequency range of 400 MHz to 1 GHz, but other frequency ranges can be used. Transponders 30 have information storage means located within them which can store various types of information such as a unique identifying number associated with that transponder, a security, information about the object to which the transponder is attached, tag history etc. In some embodiments, a unique security password can be assigned to each tag with the system storing the password associated with each transponder 30 in a table. Other embodiments may use a system wide password that can be changed periodically. The exchange of information between RAD units 20 and transponders 30 allow the asset protection system 10 to monitor the location of assets associated with the transponders. The ability of transponders 30 to store information about the asset to which they are attached and to transmit that information, allows detailed awareness of assets, and if a transponder 30 is associated with a person, awareness of that person's location as well. Also, in some embodiments, transponder 30 has onboard audible alarm capabilities. The alarm on transponder 30 can be instructed to sound by a RAD unit 20 if it is determined by the system 10 that the object to which transponder 30 is attached is being inappropriately moved, or if an unauthorized attempt is made to forcibly remove transponder 30 from an object to which it is attached. Transponder 30 may sound the alarm until instructed otherwise by system 10 or until its power is depleted. In one embodiment, a transponder has several elements including; a digital controller, memory, antenna, battery, audible alarm, locking device. Some embodiments of transponder 30 may also have a resonator or ferrite compatible with electronic article surveillance systems. In these other types of EAS systems, passive elements such as ferrites and resonators are detected by security antennas set up at exits or other restricted areas.

Each RAD unit 20 has a communication connection back to a central server 40. This connection is accomplished by cables 50 and a switch 60. In one embodiment the switch 60 is a Power over Ethernet (POE) switch which allows both information and power to be conducted over cables 50 connecting RAD units 20 to switch 60. In at least one embodiment, switch 60 provides information traffic control between the plurality of RAD units 20 and server 40. Server 40 is capable of running an off-the-shelf operating system and the software controls of the asset protection system 10 run in this server operating system. A user can establish all the rules for asset protection system and database management through a graphical user interface. The software of the asset protection system 10 provides flexibility in giving different instructions and settings to individual RAD units 20. For example, a RAD unit 20 which is located near an exit 70 of a monitored area could be instructed by settings in the software of server 40 to radiate and detect in the area near the exit 70 at a much more frequent rate than a RAD unit 20 which is in an area for inventory purposes only. The software of server 40 could also be set to instruct a RAD unit 20 at an exit 70 to set a transponder 30 to alarm continuously if it appears that the transponder, and therefore the asset it is attached to, is being removed from the monitored area. The transponder 30 would alarm until instructed otherwise by RAD unit 20, or until the onboard power source of the transponder 30 is depleted. In one embodiment, transponder 30 requires confirmation of its password from RAD unit 20 before ceasing to alarm.

The software of server 40 provides other capabilities. One embodiment uses the plurality of RAD units 20 to periodically inventory a monitored area. Another embodiment uses the RAD units to determine specific locations of transponders. In these embodiments the software of server 40 is capable of analyzing the timing of signals between RAD units 20 and transponders 30 to calculate the distance of a transponder 30 from a given RAD unit 20. For increased accuracy multiple RAD units 20 within range of the same transponder 30 can be used to triangulate a highly accurate position for that transponder 30. The radiating field of RAD units 20 can be shaped to prevent excessive overlap, or interference, between the fields of RAD units 20. In one embodiment these fields are generally conical shaped, expanding as the field extends away from a given RAD unit 20. This provides a larger area of coverage down at the level where activity typically occurs. In another embodiment the asset protection system 10 provides access control. This is accomplished by transponders 30 being associated with persons, and the transponders 30 contain information identifying the person who is wearing the transponder 30. The asset protection system 10 is able to identify the location of a particular person at an access control point, such as a security door, and then allows or denies the entry of the person by either unlocking the door, or by maintaining the door in a locked status.

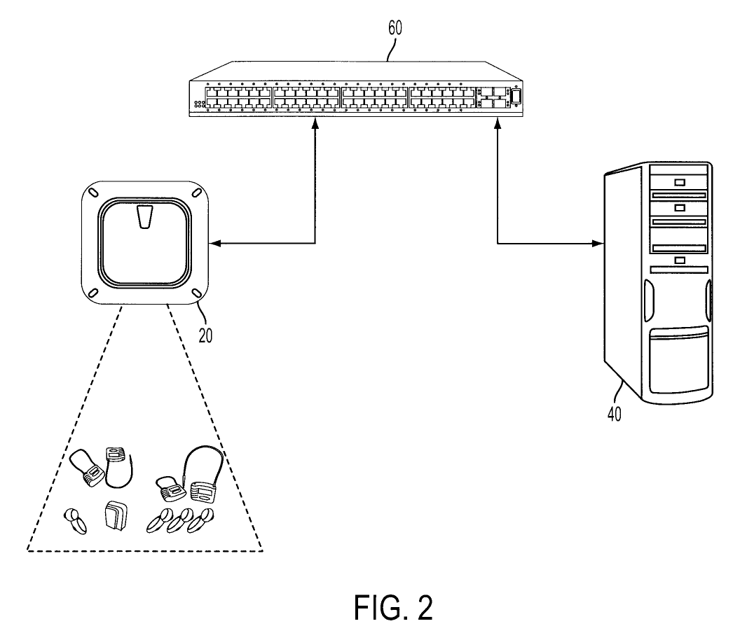

FIG. 2 shows, in more detail, components of the asset protection system 10. In particular, FIG. 2 shows the multiple ports in switch 60. These multiple ports allow the connection of a plurality of RAD units to the switch 60, and switch 60 controls data traffic between the RAD units and the server 40. Server 40 receives data from the plurality of RAD units 20 as well as sends instructions to the RAD units 20. Switch 60 also provides power to RAD units 20 over cables 50, in some embodiments.

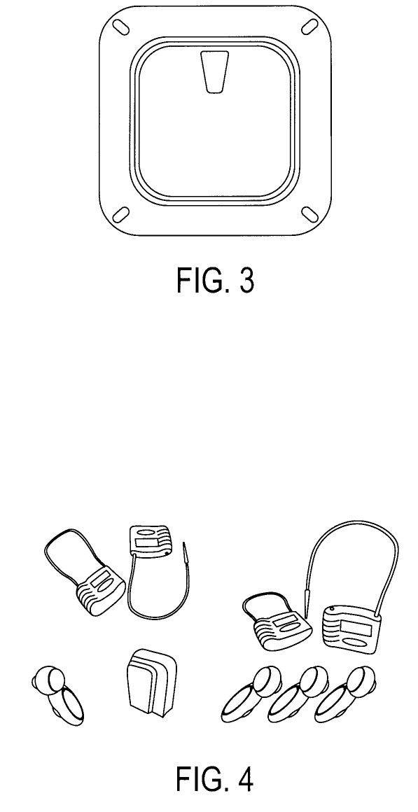

FIG. 3 shows a view of an embodiment of a RAD unit labeled in other figures as 20. RAD units 20 perform all interrogation and collection of data relative to the area to which they are assigned. RAD units can be installed above the area of interest to monitor that area. The RAD units 20 radiate their particular area and listen for any responses from transponders 30. Once a transponder is detected, or responds, the RAD unit 20 takes further action as dictated by the server software. The RAD units 20 communicate and receive instructions, settings, reprogramming, etc. from the server via large area network space (LAN) connections or cables. Each RAD unit 20 is connected back to the server 40 via the cables 50 and switch 60 as previously discussed in reference to FIG. 1.

The radiated field of RAD unit 20 can be tuned to form a cone pattern. The field generated by a particular RAD addresses transponders 30 within its area, and these transponders are awoken and respond with information. The interrogation cycle of RAD units 20 is set by the server 40. RAD units can be programmed to a range of settings from only occasionally radiating to nearly continuous radiating depending on the location of the RAD unit and the rules programmed by the user.

Depending on where a RAD unit 20 is positioned in a facility the server software can periodically interrogate each area to perform inventory checks of assets and/or people to determine presence, absence or movement, authorized or unauthorized. As discussed above, by placing a RAD unit 20 at point of egress, exit 70 location security is assured by continuously pulsing the location, and listening for a response. As the asset/person enters the radiated area, the RAD unit 20 will recognize the transponder and then enable the transponder alarm, which will continue to alarm until it is disarmed by the RAD unit 20 or the battery finally discharges. Access control can also be facilitated by transponders included with employee badges, controlling movements of assets and/or employees.

Referring now to FIG. 4, several embodiments of transponder 30 are shown. Transponders can take the form of tags, lanyards, badges, badge holders, etc. There is no reasonable limit to the transponder shape or application it can serve. Each transponder stores information specified by the server, including transponder ID, security password, and information relative to the asset or individual to which the transponder is attached. If the transponder's unique identifier (UID) or stored information needs modification, the application software can do this by uniquely addressing the transponder and then modifying its contents. Transponders also have alarming capability which can be turned on/off by the server. Transponder tampering will also cause it to alarm. In one mode of operation, each transponder is normally in a sleep mode to extend battery life and is awakened by RAD unit 20 for interaction.

Depending on the embodiment, each transponder may include a digital controller, memory, antenna, battery audible alarm, attaching mechanism and, optionally, a resonator, ferrite. The transponder is pre-coded at the time of manufacture with a readable UID. This will allow the server to uniquely access the transponder via the RAD units and make any necessary code changes. Each transponder will self-alarm if its locking mechanism is compromised or it is removed from the premises without first being disarmed. By placing a RAD unit 20 at an exit 70 location the alarm can be commanded by the RAD.

Returning now to server 40 of FIG. 1, the server software can define all the RAD unit controls, follow on actions, and data base management. The menu driven software allows the user to define each transponder and establish rules regarding its location and movement.

RAD units 20 at the points of exit 70 may be programmed to continuously radiate the area, awakening any approaching transponders. At this point, the RAD unit 20 can cause the transponder 30 to emit an audible alarm plus inform the server 40 of the detection at which time the server 40 can alert others via contact closure or electronic message.

In one embodiment, RAD units 20 may also be kept in a quiet mode and only radiate when directed. This function would be useful where certain valuables are placed in an area. As programmed by the user, the RAD unit 20 will periodically radiate the area and collect information relative to protected valuables, basically taking inventory of those assets. Employees may also be badged to ascertain their movement in much the same way as other assets. For example, if an employee attempts to remove a tagged item from the premises, not only will the items transponder be detected, but the employee's badge as well, immediately linking that employee with that item.

Referring to FIG. 1, the modular aspects of RAD units 20 allow them to be placed according to a users unique requirements as dictated by the facility within which the assets protection system 10 is installed, and according to the particular use intended for the system. As indicated in FIG. 4, transponders 30, used for any given asset protection system 10, can be specifically matched for the needs of the application. Transponders 30 may take the form of lanyard tags, personnel badges. etc. The connection of the RAD units 20 to the server is accomplished by individual cables 50 which further allows the asset monitoring system 10 to be tailored to the specific applications. The modular structure of the physical components of the asset protection system, as well as the modular component capabilities of the server software, allows the asset protection system 10 to serve an unlimited number of applications. The software of the asset protection system 10 can be interacted with via a graphical user interface for ease of interaction by a user.

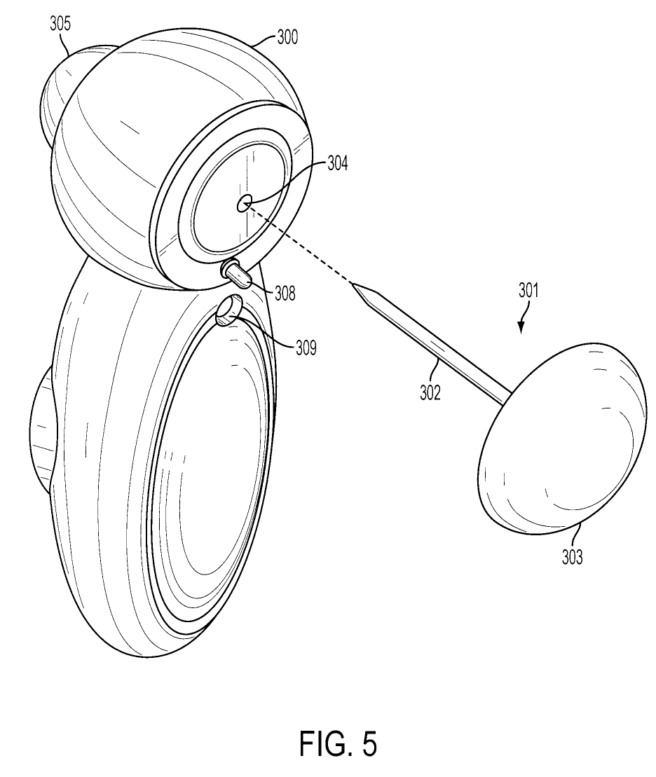

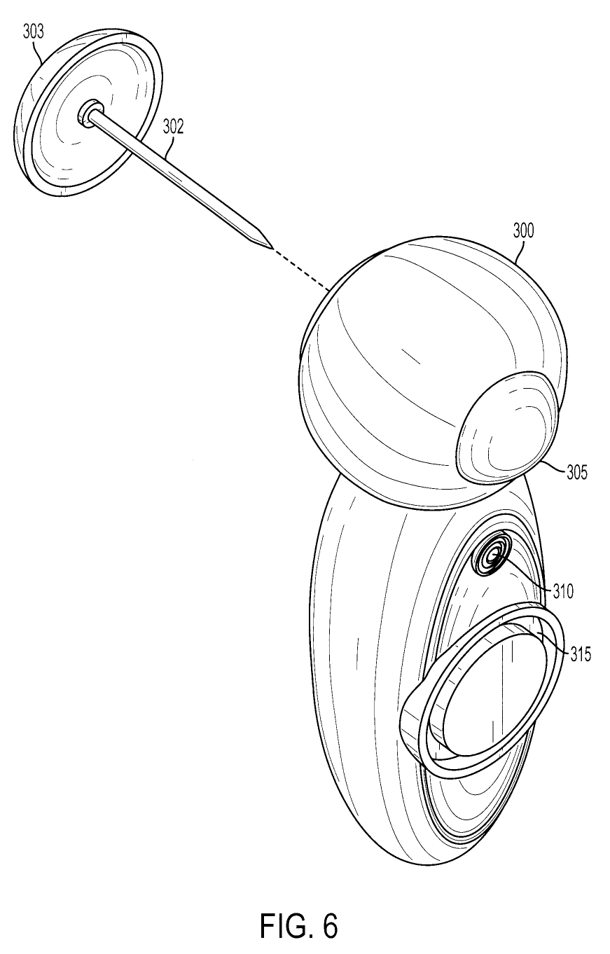

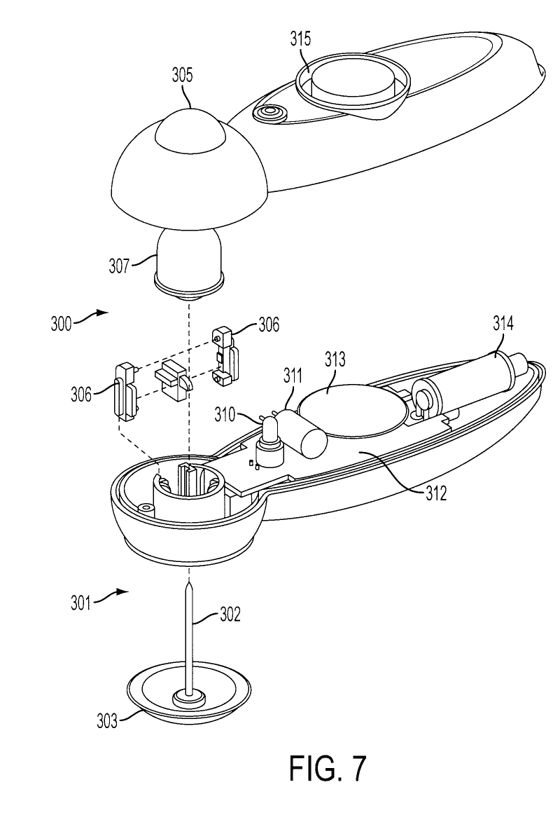

FIGS. 5 and 6 show external perspective views of an embodiment of a tack retained tag 300. Tack 301 has a shaft 302 and head 303. To retain tag 300 on an article, tack shaft 302 is passed through the article and into aperture 304, shown in FIG. 5, where tack 301 is releasably retained by a mechanism located in tag 300. In one embodiment of tag 300, the mechanism that retains tack shaft 302 in aperture 304 is a ball clutch which can be made to release tack shall 302 by application of a strong magnetic force to clutch cone 305. Another type of mechanism uses sliding wedges 306, visible in FIG. 7, to retain tack shaft 302. This embodiment can also be made to release tack shaft 302 by application of a strong magnetic force to clutch cone 305. In some embodiments clutch housing 307, visible in FIG. 7, has at least some magnetically attractable material in it, and is the element acted upon by the strong magnetic force to release the tack shaft 302.

Depending on the specific embodiment, tag, or transponder 300, may have several more features or elements in addition to those already discussed. Visible in FIG. 5 are possible elements switch button 308 and a first, top infrared communication port 309. Visible in FIG. 7 are additional possible elements including; a light emitting diode (LED) 310, battery 311, circuit board 312 with microprocessor clock, and communication antenna components (microprocessor, clock, and communication antenna components are not visible in FIG. 7), audible alarm generator 313, and EAS ferrite 314. While the embodiment of tag 300 shown in FIG. 7 has an EAS ferrite 365, other embodiments might use a resonator, which is a common detectable element used in EAS tags. Another possible element that may accompany audible alarm generator 313, is sound vent 315, most visible in FIGS. 6 and 7. Sound vent 315 allows the alarm to be more audible by allowing a path for sound to leave tag 300.

Tag 300 is capable of self alarming upon the occurrence of any one of several events. One event that can trigger self alarming by tag 300 is physical tampering with the tag. If tack 301 is forcibly removed or if tack head 303 is pried off of tack shaft 302, tag 300 will alarm with audible alarm generator 313 generating an audible sound. Switch button 308, visible in FIG. 5, is depressed by tack head 303 when tack 301 is inserted into tag 300. If tack 301 is forcibly removed or if tack head 303 is pried off of tack shaft 302, switch button 306 is released from its depressed position causing tag 300 to self alarm and also notify the system that a tag has been tampered with via the RAD unit closest to the damaged tag. Tag 300 communicates with RAD units 20 with communication antenna components located on circuit board 3 12 and can also be instructed to cease alarming by the system via the RAD units. Some embodiments of tag 300 will self alarm when the body of tag 300 is opened or otherwise compromised. In this case the self alarm may be triggered by the displacement of circuit board 312 or other means.

Another event that can trigger an alarm by the audible alarm generator 313 on board tag 300 is instruction to do so by a RAD unit. This can occur when a RAD unit generates a response from tag 300 and the RAD unit is programmed to instruct tag 300 to self alarm because that RAD unit is monitoring a sensitive area such as an exit and therefore tag 300 is in a sensitive area. For example, referring to FIG. 1, the RAD units 20 located near exit 70 can be programmed distinctly from RAD units not located as close to exit 70. RAD units 20 located near exit 70 can be programmed to instruct tags 300 in communication with those RAD units to self alarm.

A further event that may cause some embodiments of tag 300 to self alarm is interaction with more basic electronic article surveillance systems through ferrite 314, or a resonator, in some embodiments. EAS systems generate interrogation fields, usually near exits. These interrogation fields are electromagnetic fields in the radio frequency range of electromagnetic waves typically in the 58 kHz area. While the interrogation field is being generated, it develops stored energy in a ferrite, or resonator, 314 in tag 300. When the interrogation field is no longer being generated and the EAS system switches to monitoring for a signal, the energy stored in ferrite 314, dissipates and generates a signal in the process. This signal is detected by the monitoring EAS system. Detection of tag 300 by an article surveillance system will cause the article surveillance system to generate a system alarm, audible or otherwise. However, the activity in ferrite 314 is also detectable by circuit board 312 which can trigger a self alarm by tag 300.

All in all, there are several ways that various embodiments of tag 300 can generate alarms. Tag 300 can self alarm with its onboard audible alarm generator 313 when tampered with. Tag 300 can self alarm with its onboard audible alarm generator 313 when instructed to by a RAD unit. Tag 300 can self alarm with its onboard audible alarm generator 313 when it detects that an onboard electronic article surveillance element such as ferrite 314, or a resonator, is being stimulated by an electronic article surveillance interrogation zone. An article surveillance system can also generate a system alarm when it detects the presence of a tag 300 having an electronic article surveillance ferrite, or resonator, 314. In some cases, RAD unit 20 can instruct tag 300 to cease to self alarm. At least one embodiment of tag 300 requires confirmation of its password before executing instruction from a RAD unit.

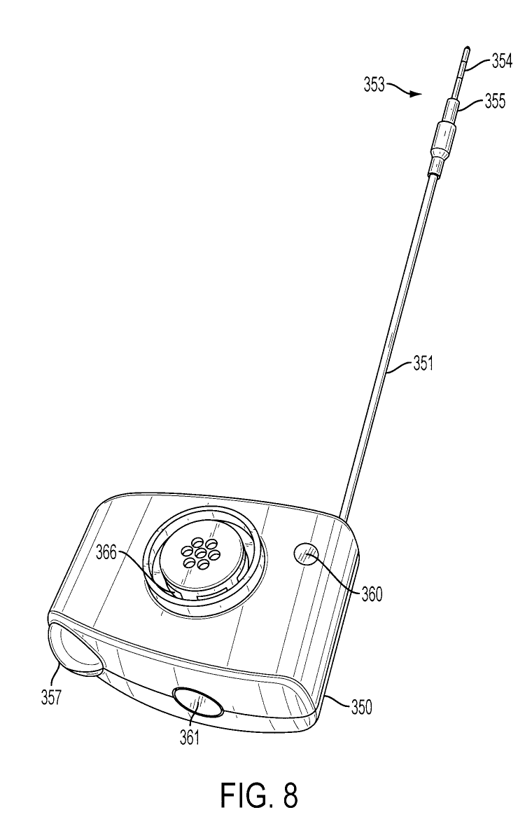

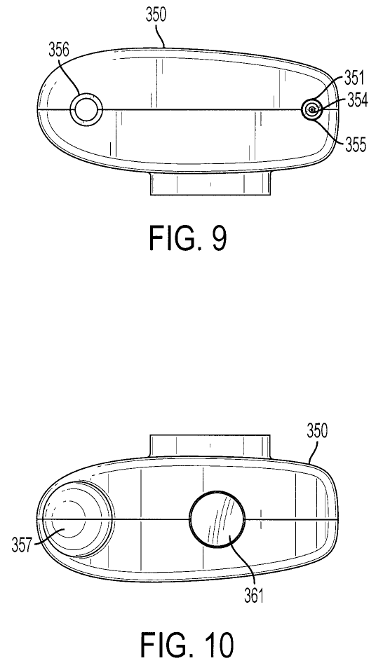

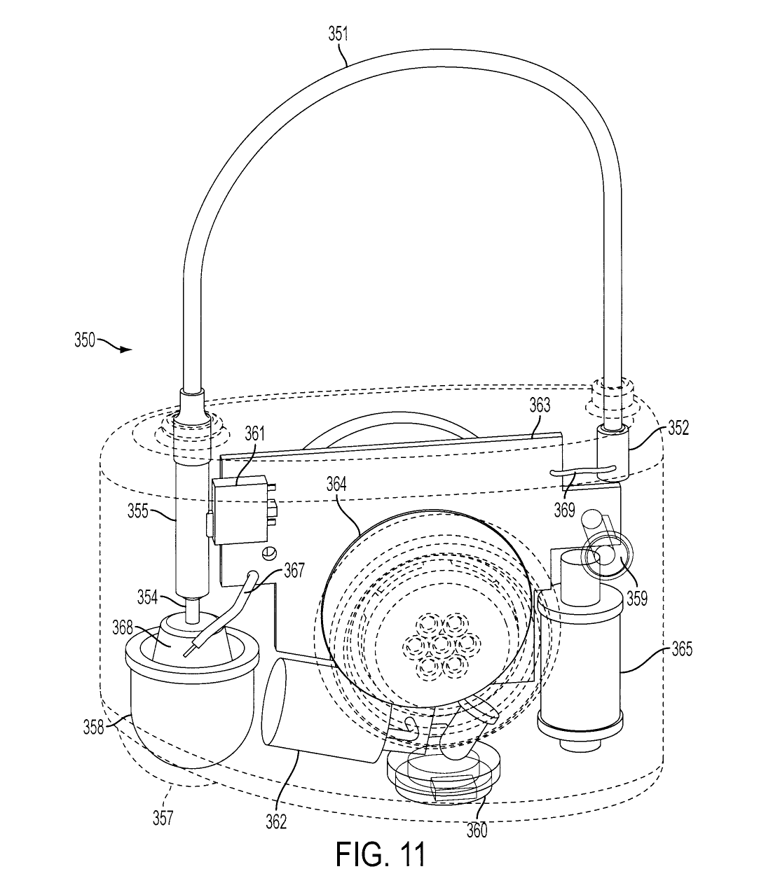

FIG. 8 shows an external perspective view of an embodiment of a lanyard retained tag, or transponder 350, while FIGS. 9 and 10 show top and bottom views of lanyard tag 350, respectively, and FIG. 11 shows internal components of lanyard tag 350. Lanyard 351 has a permanently anchored end 352 and a coupler end 353, and, in some embodiments, along its length, some portion of lanyard 351 is made of an electrically conductive material. In particular, many embodiments of lanyard tag 350 will have a lanyard 351 having its core made of an electrically conductive cable. Coupler end 353 of lanyard 351 has a retention pin 354 section and a contact cylinder 355 section. To retain lanyard tag 350 on an article, lanyard 351 is passed through the article and retention pin 354 is inserted into aperture 356, where it is retained by a mechanism located in lanyard tag 350. Alternatively to passing lanyard 351 through an article, lanyard 351 may be passed around some location on an article where it may not be easily removed. In one embodiment of tag 350, the mechanism that retains retention pin 354 in aperture 356 is a ball clutch which can be made to release retention pin 354 by application of a strong magnetic force to clutch cone 357 visible on the bottom of lanyard tag 350 in FIGS. 8, 10, and 11. In some embodiments, clutch housing 358, visible in FIG. 11, has at least some magnetically attractable material in it, and is the element acted upon by the strong magnetic force to release retention pin 354.

Depending on the specific embodiment, lanyard tag, or lanyard transponder 350, may have several more features or elements in addition to those already discussed. Visible externally in FIG. 8 are two possible elements; an infrared communication port 359 and a light emitting diode (LED) 360. Infrared communication port 359 and LED 360 are also visible in FIG. 11, while only LEI) 360 is visible in FIG. 10. Visible in FIG. 11 are additional possible elements internal to lanyard tag 350. These additional possible internal elements include; switch 361, battery 362, circuit board 363 with microprocessor, clock, and communication antenna components (microprocessor, clock, and communication antenna components are not visible in FIG. 11), audible alarm generator 364, and EAS ferrite 365. While the embodiment of lanyard tag 350 shown in FIG. 11 has an EAS ferrite 365, other embodiments might use a resonator, which is a common detectable element used in EAS tags. Another possible element that may accompany audible alarm generator 364, is sound vent 366, most visible in FIG. 6. Sound vent 366 allows the alarm to be more audible by allowing a path for sound to leave tag 350. Finally, clutch wire 367 runs from circuit board 363 to retention element 368, and lanyard wire 369 runs from circuit board 363 to anchored end 352 of lanyard 351. Clutch wire 367, lanyard wire 369, and switch 361 form circuits that assist with detecting physical tampering with lanyard tag 350.

Lanyard tag 350 is capable of self alarming upon the occurrence of any one of several events. One event that can trigger self alarming by tag 350 is physical tampering with the tag. A common attack used against lanyard type tags is the cutting of the lanyard. Referring to FIG. 111, once coupler end 353 of lanyard 351 is inserted through aperture 356 and into retention mechanism 368, two tamper detection circuits are completed. A first tamper detection circuit includes clutch wire 367, retention mechanism 368, retention pin 354, contact cylinder 355, and switch 361 and is completed on circuit board 363 (microprocessor, etc.). This first tamper detection circuit establishes that coupler end 353 of lanyard 351 has been inserted. A second tamper detection circuit includes lanyard wire 369, lanyard 351 and can be completed by two possible routes. One completion route includes contact cylinder 355, switch 361, and circuit board 363 (microprocessor etc.). Another completion route includes retention pin 354, retention mechanism 368, clutch wire 367 and circuit board 363 (microprocessor, etc.). This second tamper detection circuit monitors the integrity of lanyard 351. If lanyard 351 is cut, the first tamper detection circuit is still completed, while the second detection circuit is opened. When tag 350 detects that lanyard 351 has been cut, it self alarms with audible alarm generator 313 generating an audible sound. In addition to self alarming, tag 350 can also notify the system that a tag has been tampered with via the RAD unit closest to the damaged tag. Tag 350 communicates with RAD units 20 with communication antenna components located on circuit board 363 and can also be instructed to cease alarming by the system via the RAD units. Some embodiments of tag 350 will self alarm when the body of tag 350 is opened or otherwise compromised. In this case the self alarm may be triggered by the displacement of circuit board 363 or other means.

Another event that can trigger an alarm by the audible alarm generator 364 on board tag 350 is instruction to do so by a RAD unit. This can occur when a RAD generates a response from tag 350 and the RAD unit is programmed to instruct tag 350 to self alarm because that RAD unit is monitoring a sensitive area such as an exit and therefore tag 350 is in a sensitive area. For example, referring to FIG. 1, the RAD units 20 located near exit 70 can be programmed distinctly from RAD units not located as close to exit 70. RAD units 20 located near exit 70 can be programmed to instruct tags 350 in communication with those RAD units to self alarm.

A further event that may cause some embodiments of tag 350 to self alarm is interaction with more basic electronic article surveillance systems through ferrite 365, or a resonator, in some embodiments. EAS systems generate interrogation fields, usually near exits. These interrogation fields are electromagnetic fields in the radio frequency range of electromagnetic waves typically in the 58 kHz area. However a system may operate on any number of frequencies other than 58 kHz. While the interrogation field is being generated, it develops stored energy in ferrite 365, or a resonator, in tag 350. When the interrogation field is no longer being generated and the electronic article surveillance system is monitoring for a signal, the energy stored in ferrite 365, dissipates and generates a signal in the process. This signal is detected by the monitoring EAS system. Detection of tag 350 by an article surveillance system will cause the article surveillance system to generate a system alarm, audible or otherwise. However, the activity in ferrite 365 is also detectable by circuit board 363 which can trigger a self alarm by tag 350.

All in all, there are several ways that various embodiments of tag 350 can generate alarms. Tag 350 can self alarm with its on board audible alarm generator 364 when tampered with. Tag 350 can self alarm with its on board audible alarm generator 364 when instructed to by a RAD unit. Tag 350 can self alarm with its on board audible alarm generator 364 when it detects that an onboard electronic article surveillance element such as a ferrite 365, or a resonator, is being stimulated by an electronic article surveillance interrogation zone. An article surveillance system can also generate a system alarm when it detects the presence of a tag 350 having an electronic article surveillance ferrite, or resonator, 365. In some cases, RAD unit 20 can instruct tag 350 to cease to self alarm.

The microprocessor located in transponders 30, such as tag 300 and lanyard tag 350, and other embodiments, is capable of storing information, being reprogrammed, and performing functions through other elements in transponders 30 such as discussed as being in tag 300 and lanyard tag 350. The microprocessor can store a wide range of information communicated to it by supporting systems via radio signals, etc. For example, when a tag is attached to an article, information about that article can be transmitted to the tag and stored. In some embodiments, other, particularly important, pieces of information that a microprocessor might store includes a unique identifier associated with the respective tag and a password. The unique identifier may initially be assigned at a factory and may be altered on location when put into use. When queried by a system, the microprocessor responds with its ID, or other solicited information, via the tag's communications elements, antennas etc. As will be explained, in embodiments employing a password, the password can provide additional security in conjunction with the unique identifier, or ID, by adding an additional system element wherein a device used to detach or disarm a tag, or to instruct a tag to stop self alarming, must be able to verify a password to be able to execute the operation. For example, some transponders may be release from an article to which they are attached by the application of a strong magnetic force. Without the need for verification from the EAS system, a transponder can be detached by the application of a large unauthorized magnet. Requiring interaction with the system, such as password verification, before detaching the tag allows the microprocessor to be programmed to alarm when it is detached with no system interaction or password exchange.

Transponder embodiments employing a password may a have static, unchanging password or may employ a changeable password. Passwords that can be changed can be changed by computer via a universal serial bus (USB), by wireless infrared device, or the tag can automatically change the password using a time-based algorithm programmed into the tag's microprocessor. For tags automatically changing their passwords, other system elements, such as the server will have the same algorithm as the tag and be able to duplicate and track the password changes for each particular tag. Other system elements, such as a base station will have the same algorithm as the tag and be able to duplicate and track the password changes for each particular tag.

Embodiments using a time-based algorithm programmed into the tag's microprocessor to change the password will do so periodically. In one embodiment, transponders 30, have a highly accurate clock onboard along with the microprocessor. The microprocessor is programmed with an algorithm for changing the password for the tag and the clock is used to determine when the password should be changed according to the protocols programmed into the microprocessor. The system includes a server capable of running software. The server also has an accurate clock and possesses the algorithm programmed into the microprocessor of the tag. By knowing the initial password of a tag and marking an initial time, the server of the system can update its database to contain the correct password of a given tag as the password is changed.

Of course if the password of a transponder is changed directly by a server or RAD unit, then the password of that transponder is known to other elements of the system and the database is updated at the time of the password change. In one system embodiment, a system wide password is used and no unique transponder identifiers are needed. When the password is changed it is changed for all elements of the system, transponders, RAD units, and server. In an embodiment using a time based algorithm to periodically change passwords, all elements of the system have access to high accuracy clocks. The system elements are chronologically synchronized and the password is internally changed in each element. When system elements communicate, they each have the correct updated password.

For a transponder, or tag, using a password to be released from an article without generating an alarm, an element of the system, such as a RAD unit, must communicate with the transponder, confirm the password, and instruct the transponder microprocessor. A special tool combining microprocessor and communication capabilities with the ability to generate a strong magnetic force can unlock, or detach, a transponder while altering its settings to not alarm.

If a tag, or transponder, is not disarmed by a system element such as, for example, a RAD unit, it will alarm when detached. If the tag is not first disarmed by a system element, the tag will self-alarm when it is tampered with (forced open or a lanyard cut). If the tag is not first disarmed by a system element before it enters the interrogation field of an EAS system, the tag will self-alarm. If the tag enters the interrogation field of an EAS system, the tag will cause the EAS system to alarm.

While several embodiments are discussed in this specification, these are for illustrative purposes and should not be taken as a limiting description of the invention. As can be understood from the above description, the asset protection system can have a wide range of embodiments, as indicated with respect to specific elements and of the asset protection system 10. These elements include the RAD units 20, transponders 30, the software functions, as well as how the various elements are physically arranged with respect to each other. The modular aspect and ease of connectivity of the RAD units 20 provides simple setup, even in environments that are cluttered and fully developed, because there is no need to access standard AC power, or run antennas, etc.

I claim:

1. A modular radiate and detect unit comprising:
at least one radio frequency signal transmitting means; at least one radio frequency signal receiving means;
a receptacle adapted to receive the first end of a cable providing both a power conduit and an information conduit wherein the second end of said cable connects to a communications switch, said modular radiate and detect unit being powered by said cable; and,
at least one programmable controller for said radio frequency signal transmitting means and said radio frequency signal receiving means said programmable controller controlling signals transmitted by said radio frequency signal transmitting means and interpreting radio frequency signals received by said radio frequency signal receiving means, said at least one programmable controller performing data functions and communicating with a computer via said cable and said communications switch.

2. The modular radiate and detect unit of claim 1, wherein:
said at least one programmable controller can be programmed and reprogrammed by said computer via said cable.

3. The modular radiate and detect unit of claim 1, wherein:
said at least one radio frequency signal transmitting means and said at least one radio frequency signal receiving means are combined into a transceiver.

4. The modular radiate and detect unit of claim 1, wherein:
said at least one radio frequency signal transmitting means transmits an interrogation signal.

5. The modular radiate and detect unit of claim 1, wherein:
said at least one radio frequency signal receiving means detects electronic surveillance transponders.

6. The modular radiate and detect unit of claim 1, wherein:
said at least one radio frequency signal transmitting means transmits information or instructions to at least one electronic surveillance transponder, said information including a unique identifier for each of said at least one electronic surveillance transponders, said instructions including turning on and off an onboard alarm on each said at least one electronic surveillance transponder.

7. The modular radiate and detect unit of claim 1, wherein:
said at least one radio frequency signal receiving means receives information from electronic surveillance transponders.

8. The modular radiate and detect unit of claim 6, wherein:
said at least one radio frequency signal transmitting means transmits information and instructions to electronic surveillance transponders, programming said transponders and turning transponder alarms on and off.

9. A modular electronic surveillance system comprising:
a computer;
a communications switch;
at least one modular radiate and detect unit, said at least one modular radiate and detect unit comprising,
at least one radio frequency signal transmitting means;
at least one radio frequency signal receiving means;
a receptacle adapted to receive the first end of a cable providing both a power conduit and an information conduit wherein the second end of said cable connects to said communications switch, said modular radiate and detect unit being powered by said cable;
at least one programmable controller for said radio frequency signal transmitting means and said radio frequency signal receiving means, said programmable controller controlling signals transmitted by said radio frequency signal transmitting means and interpreting radio frequency signals received by said radio frequency signal receiving means, said at least one programmable controller communicating with said computer via said cable and said communications switch; and,
at least one transponder capable of communicating with at least one said radiate and detect unit.

10. The modular electronic surveillance system of claim 9, wherein:
said computer can program and reprogram said controller in each of said at least one modular radiate and detect units.

11. The modular electronic surveillance system of claim 9, wherein:
said controller in each of said at least one modular radiate and detect units can be programmed to operate differently from other controllers in said modular radiate and detect units.

12. The modular electronic surveillance system of claim 9, wherein:
each of said at least one radiate and detect units detects electronic surveillance transponders in its area of operation.

13. The modular electronic surveillance system of claim 9, wherein; each of said at least one transponders has a transponder controller.

14. The modular electronic surveillance system of claim 13, wherein;
each of said transponder controllers are programmable by said radiate and detect units.

15. A modular electronic surveillance system comprising:
a computer;
a communications switch;
at least one modular radiate and detect unit, said at least one modular radiate and detect unit comprising,
at least one radio frequency signal transmitting means;
at least one radio frequency signal receiving means;
a receptacle adapted to receive the first end of a cable providing both a power conduit and an information conduit wherein the second end of said cable connects to said communications switch, said modular radiate and detect unit being powered by said cable;
at least one programmable controller for said radio frequency signal transmitting means and said radio frequency signal receiving means, said programmable controller controlling signals transmitted by said radio frequency signal transmitting means and interpreting radio frequency signals received by said radio frequency signal receiving means, said at least one programmable controller communicating with said computer via said cable and said communications switch; and,
at least one transponder capable of communicating with at least one said radiate and detect unit, said transponder comprising a transponder controller, memory, an internal, antenna, a battery, an attaching mechanism for releasably attaching said transponder to an article, an electronic article surveillance sensor, and an audible alarm generator.

16. The modular electronic surveillance system of claim 15, wherein:
said computer can program and reprogram said controller in each of said at least one modular radiate and detect units.

17. The modular electronic surveillance system of claim 16, wherein:
each of said transponder controllers are programmable by said radiate and detect units.
